(19) United States
(12) Patent Application Publication
(10) Pub. No.: US 2021/0110488 A1
(43) Pub. Date: Apr. 15, 2021

(54) CONSTRUCTION SITE MANAGEMENT DEVICE, OUTPUT DEVICE, AND CONSTRUCTION SITE MANAGEMENT METHOD

(71) Applicant: Komatsu Ltd., Tokyo (JP)

(72) Inventor: Yoshiyuki Onishi, Tokyo (JP)

(21) Appl. No.: 16/498,462

(22) PCT Filed: Jun. 27, 2018
(86) PCT No.: PCT/JP2018/024375

§ 371 Date: Sep. 27, 2019

(30) Foreign Application Priority Data
Jul. 18, 2017 (JP) 2017-139409

(51) Int. Cl. G06Q 50/08; G06Q 10/06; E02F 9/26; E02F 9/20; G07C 5/00

(52) U.S. Cl. CPC G06Q 50/08; G06Q 10/06; G07C 5/008; E02F 9/2054; E02F 9/26

(57) ABSTRACT

A construction site management device generates a dynamic state image which includes a map including a construction site, a vehicle mark representing a portion corresponding to a location where a vehicle disposed in the construction site on the map is located, identification information of the vehicle indicated by the vehicle mark, and a standstill mark representing a portion corresponding to a location where the vehicle is at a standstill, and which represents a dynamic state of the vehicle in a predetermined period.

### TECHNICAL FIELD

The present invention relates to a construction site management device, an output device, and a construction site management method.

Priority is claimed on Japanese Patent Application No. 2017-139409, filed on Jul. 18, 2017, the content of which is incorporated herein by reference.

### BACKGROUND ART

PTL 1 discloses a technique in which a map of a construction site, and the current positions of a work machine and a transport vehicle are displayed.

### CITATION LIST

### Patent Literature

[PTL 1] Japanese Patent No. 3687850

### SUMMARY OF INVENTION

### Technical Problem

A transport vehicle transporting earth and sand and a work machine performing earth cut work and banking work are disposed at a construction site. There is a desire to examine the causes of bottlenecks in terms of efficiency of transport vehicles and work machines at construction sites. Behaviors of the work machines and the transport vehicles are logged, but it is difficult to find bottlenecks by reading obtained log data. In the technique disclosed in PTL 1, it is not possible to look back on a day and to examine what kind of problem occurred at a construction site.

An aspect of the present invention is directed to providing a construction site management device, an output device, and a construction site management method capable of easily recognizing a bottleneck in the work of a transport vehicle and a work machine.

### Solution to Problem

According to a first aspect of the present invention, there is provided a construction site management device including a map acquisition unit that acquires map information including a construction site and a traveling path; a position data acquisition unit that acquires a time series of position data of a vehicle; a dynamic state image generation unit that generates a dynamic state image which includes the map information and a vehicle mark representing a portion corresponding to a location where the vehicle disposed in the construction site on the map information is located and which represents a dynamic state of the vehicle in a predetermined period, on the basis of the time series of position data; and an output control unit that outputs an output signal enabling the dynamic state image to be output, to an output device.

### Advantageous Effects of Invention

According to the aspect, the construction site management device enables a bottleneck in the work of a transport vehicle and a work machine to be easily recognized.

### BRIEF DESCRIPTION OF DRAWINGS

FIG. 1 is a diagram illustrating an example of a construction site which is a management target of a construction site management device according to a first embodiment.

FIG. 2 is a flowchart illustrating an operation of loading work of a hydraulic excavator.

FIG. 3 is a flowchart illustrating an operation of laying-leveling work of a bulldozer.

FIG. 4 is a schematic block diagram illustrating a configuration of a construction site management device according to the first embodiment.

FIG. 5 is a diagram illustrating data stored in a time-series storage unit.

FIG. 6 is a flowchart illustrating a dynamic state image output method according to the first embodiment.

FIG. 7 is a flowchart illustrating a method of identifying a state of a hydraulic excavator disposed in an earth cut place in the first embodiment.

FIG. 8 is a diagram illustrating an example of time series of azimuth data of the hydraulic excavator.

FIG. 9 is a flowchart illustrating a method of identifying a state of a hydraulic excavator disposed in a banking place in the first embodiment.

FIG. 10 is a flowchart illustrating a method of identifying a state of a slope excavator in the first embodiment.

FIG. 11 is a flowchart illustrating a method of identifying a state of a bulldozer in the first embodiment.

FIG. 12 is a flowchart illustrating a method of identifying a state of a dump truck in the first embodiment.

FIG. 13 illustrates an example of a time chart generated by the construction site management device according to the first embodiment.

FIG. 14 is a flowchart illustrating a method in which the construction site management device according to the first embodiment generates a dynamic state image.

FIG. 15 illustrates an example of a dynamic state image according to the first embodiment.

FIG. 16 is a flowchart illustrating a method of identifying a state of a dump truck in a second embodiment.

### DESCRIPTION OF EMBODIMENTS

### First Embodiment

«Construction Site»

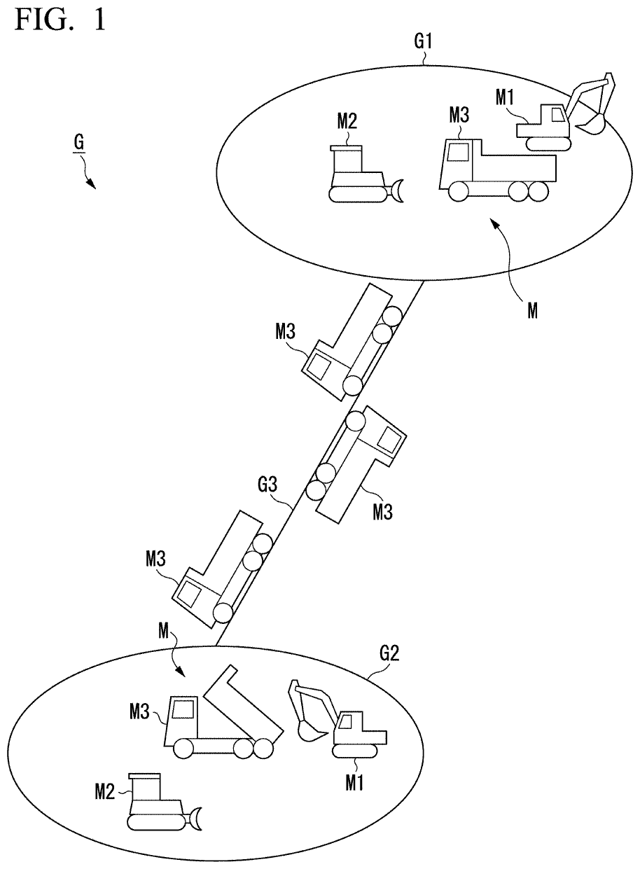

FIG. 1 is a diagram illustrating an example of a construction site which is a management target of a construction site management device according to a first embodiment.

A construction site G according to the first embodiment has an earth cut place G1 and a banking place G2. The earth cut place G1 and the banking place G2 are connected to each other via a traveling path G3. A time chart I2 includes a general road connecting the earth cut place G1 to the banking place G2, and a transport path for transport of earth and sand prepared in the construction site G A hydraulic excavator M1 and a bulldozer M2 are disposed in each of the earth cut place G1 and the banking place G2. A plurality of dump trucks M3 travel between the earth cut place G1 and the banking place G2. The hydraulic excavator M1, the bulldozer M2, and the dump truck M3 are examples of a vehicle M. In other embodiments, in the earth cut place G1 and the banking place G2, a plurality of hydraulic excavators M1 may be disposed, a plurality of bulldozers M2 may be disposed, one of the hydraulic excavator M1 and the bulldozer M2 is not necessarily disposed, and other vehicles M may be disposed.

«Vehicle»

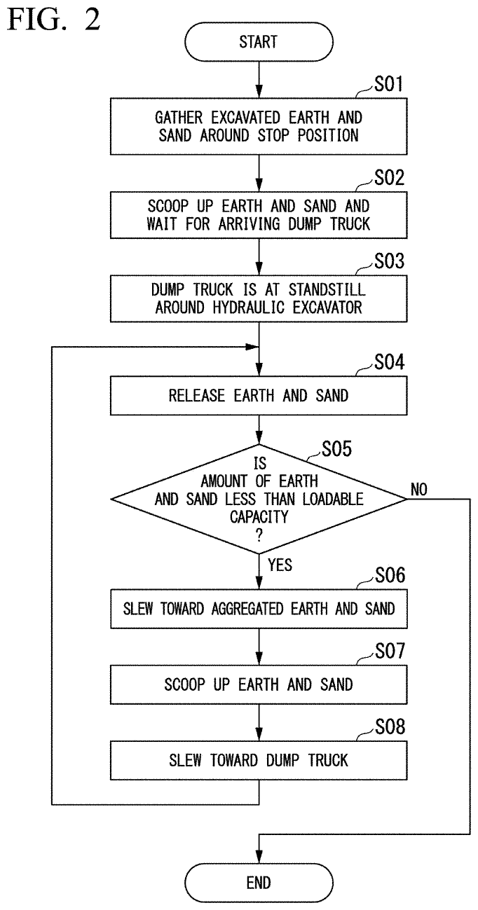

The hydraulic excavator M1 disposed in the earth cut place G1 excavates earth and sand in the earth cut place G1, and loads the earth and sand onto the dump truck M3. FIG. 2 is a flowchart illustrating an operation of loading work of the hydraulic excavator.

An operator of the hydraulic excavator M1 aggregates excavated earth and sand around a standstill position of the dump truck M3 in advance before the dump truck M3 arrives (step S01). The operator of the hydraulic excavator M1 scoops up a load of earth and sand with the hydraulic excavator M1 before the dump truck M3 arrives (step S02). In a case where there is no margin in work time, the work in steps S01 and S02 may be omitted. In a case where the dump truck M3 reaches a predetermined loading region of the earth cut place G1, the dump truck M3 is at a standstill around the hydraulic excavator M1 (step S03). Next, the operator of the hydraulic excavator M1 releases the scooped-up earth and sand into the dump body of the dump truck M3 (step S04). The operator of the hydraulic excavator M1 estimates whether or not an amount of earth and sand loaded on the dump truck M3 is less than a loadable capacity of the dump truck M3 (step SOS). In a case where it is determined that the amount of earth and sand loaded on the dump truck M3 is less than the loadable capacity of the dump truck M3 (step S05: YES), the operator of the hydraulic excavator M1 slews an upper slewing body of the hydraulic excavator M1 toward aggregated earth and sand or earth and sand to be excavated (step S06). The operator of the hydraulic excavator M1 scoops up the aggregated earth and sand or the excavated earth and sand with the hydraulic excavator M1 (step S07). Next, the operator of the hydraulic excavator M1 slews the upper slewing body of the hydraulic excavator M1 toward the dump truck M3 (step S08), and releases the earth and sand in the same manner as in the process in step S4. This is repeatedly executed, and thus the operator of the hydraulic excavator M1 can load earth and sand up to the loadable capacity of the dump truck M3. In a case where it is determined that an amount of earth and sand loaded on the dump truck M3 reaches the loadable capacity of the dump truck M3 (step S05: NO), the operator of the hydraulic excavator M1 finishes the loading work of the hydraulic excavator M1.

The hydraulic excavator M1 disposed in the earth cut place G1 may shape a slope in the earth cut place G1. The operator of the hydraulic excavator M1 causes the hydraulic excavator M1 to come close to a slope region designed as a slope, and shapes earth and sand on a surface of the slope region with a bucket while moving in an extending direction of the slope. Hereinafter, the hydraulic excavator M1 for slope shaping work will be referred to as a slope excavator in some cases.

The bulldozer M2 disposed in the earth cut place G1 excavates and transports earth and sand in the earth cut place G1. An operator of the bulldozer M2 moves the bulldozer M2 forward in a state in which a position of a blade of the bulldozer M2 is adjusted, and can thus excavate earth and sand with the bulldozer M2. The bulldozer M2 disposed in the earth cut place G1 compacts a ground after excavation. The operator of the bulldozer M2 causes the bulldozer M2 to travel in a state in which the blade of the bulldozer M2 is raised, and can thus compact the ground with the bulldozer M2. A traveling speed of the bulldozer M2 during compaction is higher than a traveling speed during excavation.

The dump truck M3 transports the earth and sand loaded in the earth cut place G1 to the banking place G2. In a case where the dump truck M3 unloads the earth and sand in the banking place G2, the dump truck M3 is moved from the banking place G2 to the earth cut place G1. A traveling speed of the dump truck M3 differs between when the dump truck M3 is loaded with earth and sand and when the dump truck M3 is not loaded therewith. A traveling speed of the dump truck M3 differs between when the dump truck M3 is traveling inside the banking place G2 or the earth cut place G1 and when the dump truck M3 is traveling on the traveling path G3 as the outside.

In a case where the dump truck M3 is at a standstill at a standstill position in each of the earth cut place G1 and the banking place G2, an operator of the dump truck M3 turns the dump truck M3, and causes the dump truck M3 to travel backward and thus to be at a standstill at the standstill position.

The hydraulic excavator M1 disposed in the banking place G2 heaps up the earth and sand unloaded from the dump truck M3 in the banking place G2. In this case, in the same manner as the hydraulic excavator M1 disposed in the earth cut place G1, the hydraulic excavator M1 disposed in the banking place G2 repeatedly executes processes of directing an upper slewing body thereof toward the unloaded earth and sand, scooping up the earth and sand, slewing the upper slewing body to a location where the earth and sand are to be scattered, and releasing the earth and sand to the location where the earth and sand are to be scattered.

The hydraulic excavator M1 disposed in the banking place G2 may shape a slope in the banking place G2.

The bulldozer M2 disposed in the banking place G2 lays and levels the earth and sand transported by the dump truck M3 in the banking place G2. Specifically, the bulldozer M2 uniformly lays and levels earth and sand discharged by the dump truck M3 or the like in a region in which the earth and sand are to be laid and leveled. In the laying-leveling work, the height of the earth and sand to be laid once, that is, the height of a landform to be heaped up more than before laying and leveling is defined depending on the current situation of the construction site G or by an operator. In order to lay and level discharged earth and sand to a predetermined height, the bulldozer M2 sets its blade at a predetermined height, and then performs the laying-leveling work. The laying-leveling work is repeatedly performed a plurality of times until a region where earth and sand are to be laid and leveled reaches a target height.

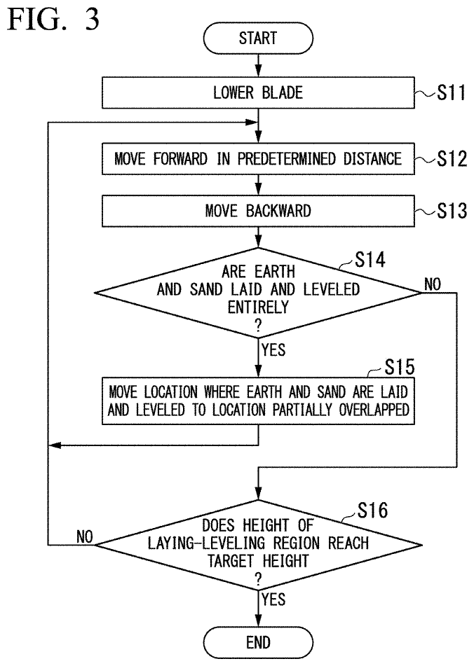

FIG. 3 is a flowchart illustrating an operation of laying-leveling work of the bulldozer.

In a case where earth and sand are scattered by the dump truck M3 in a region where the earth and sand are to be laid and leveled, the operator of the bulldozer M2 lowers the blade to any height (step S11). The height of earth and sand to be laid and leveled is determined by the height of the blade. Next, the operator of the bulldozer M2 moves the bulldozer M2 forward in the laying-leveling region, so as to level the earth and sand (step S12). The bulldozer M2 is moved forward once, and thus the earth and sand can be laid and leveled up to the front by a predetermined distance (for example, about 10 meters). In a case where the bulldozer M2 is moved forward by the predetermined distance, the operator of the bulldozer M2 moves the bulldozer M2 backward (step S13). The operator of the bulldozer M2 determines whether or not the earth and sand are laid and leveled in the entire laying-leveling region with the bulldozer M2 (step S14). In a case where there is a location where earth and sand are not laid and leveled (step S14: NO), the operator of the bulldozer M2 moves the bulldozer M2 such that the blade is adjusted to a position which include the location where earth and sand are not laid and leveled and partially overlaps a location where earth and sand are already laid and leveled (step S15). For example, the operator of the bulldozer M2 moves the bulldozer M2 obliquely backward during backward movement in step S13. The flow returns to the process in step S12, and forward movement and backward movement are repeated until earth and sand are laid and leveled in the entire laying-leveling region. In a case where it is determined that earth and sand are laid and leveled in the entire laying-leveling region (step S14: YES), the operator of the bulldozer M2 determines whether or not the height of the laying-leveling region has reached the target height (step S16). In a case where it is determined that the height of the laying-leveling region has not reached the target height (step S16: NO), the flow returns to the process in step S12, and forward movement and backward movement are repeated until the height of the laying-leveling region reaches the target height. On the other hand, in a case where it is determined that the height of the laying-leveling region reaches the target height (step S16: YES), the operator of the bulldozer M2 finishes the laying-leveling work of the bulldozer M2.

The bulldozer M2 disposed in the banking place G2 may compact the ground. The operator of the bulldozer M2 raises the blade of the bulldozer M2, causes the bulldozer M2 to travel, and can thus compact the ground with a crawler of the bulldozer M2. A traveling speed of the bulldozer M2 during compaction is higher than a traveling speed during laying-leveling work.

«Configuration of Construction Site Management Device»

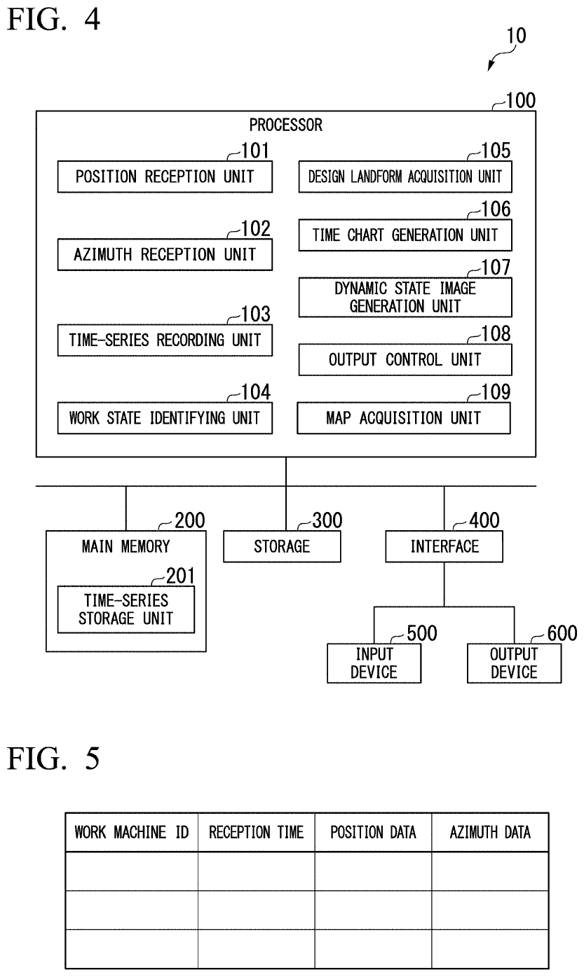

FIG. 4 is a schematic block diagram illustrating a configuration of a construction site management device according to the first embodiment. A construction site management device 10 identifies a state of each vehicle M at each time point at the construction site G and outputs the state in the form of a time chart.

The construction site management device 10 is a computer including a processor 100, a main memory 200, a storage 300, and an interface 400. The storage 300 stores a program. The processor 100 reads the program from the storage 300, develops the program to the main memory 200, and executes processes according to the program. The construction site management device 10 is connected to a network via the interface 400. The construction site management device 10 is connected to an input device 500 and an output device 600 via the interface 400. Examples of the input device 500 may include a keyboard, a mouse, and a touch panel. Examples of the output device 600 may include a monitor, a speaker, and a printer.

Examples of the storage 300 may include a hard disk drive (HDD), a solid state drive (SSD), a magnetic disk, a magnetooptical disc, a compact disc read only memory (CD-ROM), a digital versatile disc read only memory (DVD-ROM), and a semiconductor memory. The storage 300 may be an internal medium which is directly connected to a bus of the construction site management device 10, and may be an external medium which is connected to the construction site management device 10 via the interface 400. The storage 300 is a non-transitory storage medium.

The processor 100 functions as a position reception unit 101, an azimuth reception unit 102, a time-series recording unit 103, a state identifying unit 104, a design landform acquisition unit 105, a time chart generation unit 106, a dynamic state image generation unit 107, an output control unit 108, and a map acquisition unit 109, according to the execution of the program.

The processor 100 secures storage regions of a time-series storage unit 201 in the main memory 200 according to execution of the program.

The position reception unit 101 receives position data of each vehicle M disposed in the construction site G every predetermined time. The position data of the vehicle M may be received from a computer of the vehicle M, and may be received from a computer carried by the vehicle M. An example of the computer carried by the vehicle M may include a smart phone. The position reception unit is an example of a position data acquisition unit.

The azimuth reception unit 102 receives azimuth data of each vehicle M disposed in the construction site G every predetermined time. The azimuth data of the vehicle M may be received from a computer of the vehicle M, and may be received from a computer carried by the vehicle M. In a case where the computer carried by the vehicle M transmits the azimuth data, the computer is fixed to the vehicle M such that the computer is not rotated. The azimuth data includes not only output data from a sensor such as an electronic compass or a geomagnetic sensor but also detection (including PPC pressure) of a slewing lever operation, or a detection result in a gyro sensor or an angle sensor of an upper slewing body. In other words, the azimuth reception unit 102 may identify the azimuth of the vehicle M by integrating an instantaneous change amount of the azimuth. The azimuth data may be detected by a sensor provided in the vehicle M or a sensor provided outside of the vehicle M. The sensor may, for example, detect azimuth data through image analysis using a motion sensor or a camera.

The time-series recording unit 103 stores the position data received by the position reception unit 101 and the azimuth data received by the azimuth reception unit 102 into the time-series storage unit 201 in association with an ID of the vehicle M and reception times thereof. FIG. 5 is a diagram illustrating data stored in the time-series storage unit. Consequently, the time-series storage unit 201 stores a time series of position data of each vehicle M and a time series of azimuth data of each vehicle M. The time series of the position data and the azimuth data may be an aggregate of position and azimuth data every predetermined time, and may be an aggregate of position and position data at an irregular time.

The state identifying unit 104 identifies a work state of each vehicle M on the basis of a time series of position data and a time series of azimuth data stored in the time-series storage unit 201, and a time series of traveling speeds. Examples of the work state of the vehicle M may include the type of work executed by the vehicle M, a location where the vehicle M is located, and a traveling direction (forward movement or backward movement) of the vehicle M.

The type of work of the hydraulic excavator M1 may include excavation work, loading work, banking work, scattering work, and slope shaping work. The excavation work is, for example, excavating earth and sand at the construction site G. The loading work is, for example, loading excavated earth and sand onto the dump truck M3. The banking work is, for example, piling and compacting earth and sand discharged by the dump truck M3 at the construction site G. The scattering work is, for example, scattering and spreading earth and sand discharged by the dump truck M3 at the construction site G The slope shaping work is, for example, excavating and shaping a slope region in the construction site G in accordance with design landform data.

The type of work of the bulldozer M2 may include excavation-transport work, laying-leveling work, and compaction work. The excavation-transport work is, for example, excavating and transporting earth and sand at the construction site G with the blade. The laying-leveling work is, for example, laying and leveling earth and sand discharged by the dump truck M3 to a predetermined height. The compaction work is, for example, compacting earth and sand at the construction site G with the crawler.

The type of work of the dump truck M3 may include unloaded traveling, loaded traveling, loading work, and discharge work. The unloaded traveling is, for example, traveling in a state in which there is no earth or sand in the dump body. The loaded traveling is, for example, traveling in a state in which there is earth or sand in the dump body. The loading work is standby work while earth and sand are loaded into the dump body by the hydraulic excavator M1. The discharge work is work of unloading earth and sand loaded in the dump body.

The state identifying unit 104 identifies whether the traveling state of the bulldozer M2 is forward movement or backward movement. The state identifying unit 104 identifies whether the dump truck M3 is located in the earth cut place G1 or the banking place G2 and whether the dump truck is being turned or moved backward, as the dump truck's traveling state. The traveling state is an example of a work state.

The design landform acquisition unit 105 acquires design landform data representing a design landform of the construction site G. The design landform data is three-dimensional data, and includes position data in a global coordinate system. The design landform data includes landform type data indicating the type of landform. The design landform data is created by, for example, three-dimensional CAD.

The time chart generation unit 106 generates a time chart on the basis of the type of work identified by the state identifying unit 104. The time chart according to the first embodiment is a chart in which a longitudinal axis expresses time, and the vehicles M are arranged on a transverse axis, and a work content of each vehicle is displayed in each time period.

The dynamic state image generation unit 107 generates a dynamic state image representing a dynamic state of the vehicle M in a predetermined period. The dynamic state image according to the first embodiment is a moving image in which a position of a vehicle mark representing the vehicle M temporarily changes according to a time series of position data on a map including the construction site.

The output control unit 108 outputs an output signal causing the dynamic state image generated by the dynamic state image generation unit 107 to be output, to the output device 600.

The map acquisition unit 109 acquires map information from the storage 300 or an external server, and stores the map information into the main memory 200.

«Dynamic State Image Output Method»

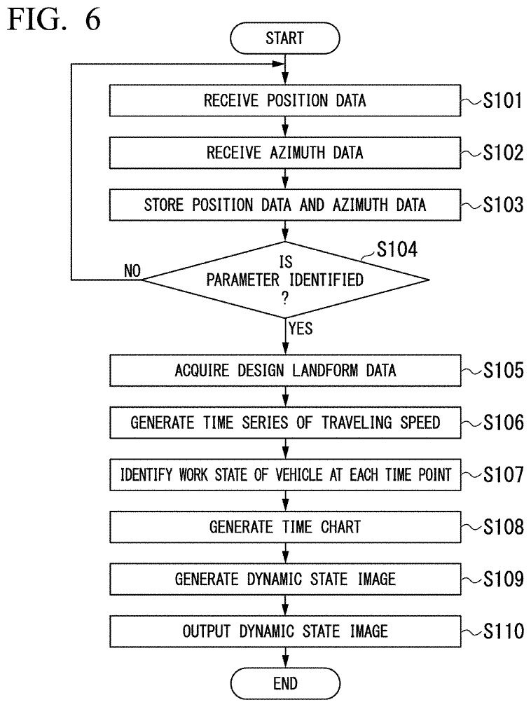

Next, a description will be made of an operation of the construction site management device 10 according to the first embodiment. FIG. 6 is a flowchart illustrating a dynamic state image output method according to the first embodiment.

The construction site management device 10 regularly collects position data and azimuth data from each vehicle M during a period which is a target of a dynamic state image, and generates time-series data.

A computer mounted on each vehicle M or a computer carried by each vehicle M (hereinafter, referred to as a computer of the vehicle M) measures a position and an azimuth of the vehicle M every predetermined time. The computer of the vehicle M transmits position data indicating the measured position and azimuth data indicating the measured azimuth to the construction site management device 10. The position of the vehicle M is identified by a global navigation satellite system (GNSS) such as a global positioning system (GPS). The azimuth of the vehicle M is identified by, for example, an electronic compass provided in the vehicle M or the computer of the vehicle M.

The position reception unit 101 of the construction site management device 10 receives the position data from the computer of the vehicle M (step S101). The azimuth reception unit 102 receives the azimuth data from the computer of the vehicle M (step S102). The time-series recording unit 103 stores the received position data and azimuth data into the time-series storage unit 201 in association with reception time points and an ID of the vehicle M related to the computer which is a reception source (step S103). The construction site management device 10 determines whether or not a parameter identifying process is started due to a user's operation or the like (step S104).

In a case where the parameter identifying process is not started (step S104: NO), the construction site management device 10 repeatedly executes the processes from step S101 to step S103 until the parameter identifying process is started, and thus a time series of position data and azimuth data is formed in the time-series storage unit 201.

In a case where the dynamic state image target period is finished (step S104: YES), the design landform acquisition unit 105 acquires design landform data (step S105). The state identifying unit 104 calculates a traveling speed of each vehicle M at each time point on the basis of the time series of position data of each vehicle M stored in the time-series storage unit 201 (step S106). In other words, the state identifying unit 104 generates a time series of traveling speeds of each vehicle M. The time series of traveling speeds may be acquired by using control area network (CAN) data of the vehicle M. Next, the state identifying unit 104 identifies a work state of each vehicle M at each time point on the basis of the design landform data, and the position data, the azimuth data, and the time series of traveling speeds of the vehicle M (step S107). The time chart generation unit 106 generates a time chart on the basis of the state identified by the state identifying unit 104 (step S108). The dynamic state image generation unit 107 generates a dynamic state image representing a dynamic state of the vehicle M by using the time series of position data, azimuth data, and traveling speed of the vehicle M stored in the time-series storage unit 201, and the generated time chart (step S109). The output control unit 108 outputs an output signal causing the dynamic state image generated by the dynamic state image generation unit 107 to be output, to the output device 600 (step S110).

Here, a detailed description will be made of a method in which the state identifying unit 104 identifies a state in step S107.

«Method of Identifying Work State of Hydraulic Excavator M1 Disposed in Earth Cut Place G1»

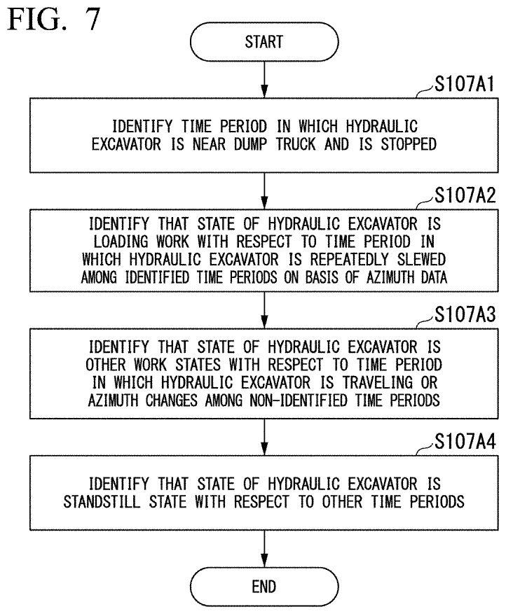

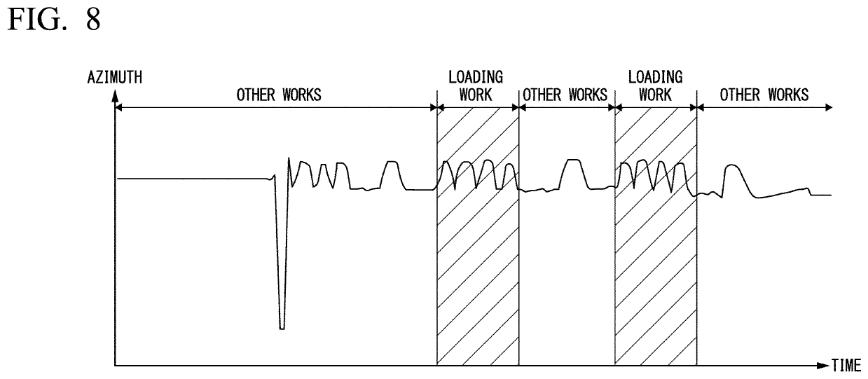

FIG. 7 is a flowchart illustrating a method of identifying a work state of the hydraulic excavator disposed in the earth cut place in the first embodiment. FIG. 8 is a diagram illustrating an example of a time series of azimuth data of the hydraulic excavator.

The state identifying unit 104 identifies time periods in which the dump truck M3 is located within a predetermined distance from the hydraulic excavator M1 disposed in the earth cut place G1, and the hydraulic excavator M1 and the dump truck M3 are stopped, on the basis of a time series of position data and a time series of traveling speeds (step S107A1). The vehicle M “being stopped” indicates a work state in which the vehicle M is not traveling. In other words, a state in which the vehicle M is not traveling, and performs work such as excavation, slewing, raising and lowering a boom is also referred to as the vehicle M “being stopped”. On the other hand, a work state in which the vehicle M is not traveling and also does not perform other work will be referred to as the vehicle M “being at a standstill”. Next, the state identifying unit 104 identifies that a work state (the type of work) of the hydraulic excavator M1 is a loading work state with respect to a time period in which the hydraulic excavator M1 is repeatedly slewed among the identified time periods on the basis of a time series of azimuth data (step S107A2). The state identifying unit 104 may determine that the hydraulic excavator M1 is repeatedly slewed, for example, in a case where slewing in which an azimuth of the hydraulic excavator consecutively changes in the same direction at an angle equal to or higher than a predetermined angle (for example, 10 degrees) is repeatedly performed in right-left directions a predetermined number of times or more among the identified time periods. This is because the cycle operation from step S04 to step S08 illustrated in FIG. 2 appears as a repeated change in an azimuth of the hydraulic excavator M1 as illustrated in FIG. 8. In FIG. 8, a hatched portion represents a time period in which a distance between the hydraulic excavator M1 and the dump truck M3 is within a predetermined distance. As illustrated in FIG. 8, the state identifying unit 104 determines that a work state of the hydraulic excavator M1 is a loading work state in the time period in which a distance between the hydraulic excavator M1 and the dump truck M3 is within the predetermined distance, and repeated slewing is performed.

Next, the state identifying unit 104 identifies that a work state of the hydraulic excavator M1 is another work state with respect to a time period in which the hydraulic excavator M1 is traveling or an azimuth of the hydraulic excavator M1 changes among time periods in which a work state of the hydraulic excavator M1 is not identified (step S107A3). The other work states include excavation work and work of aggregating earth and sand to be loaded.

Next, the state identifying unit 104 identifies that a work state of the hydraulic excavator M1 is a standstill state with respect to the time period in which a work state of the hydraulic excavator M1 is not identified (step S107A4).

«Method of Identifying Work State of Hydraulic Excavator M1 Disposed Banking Place G2»

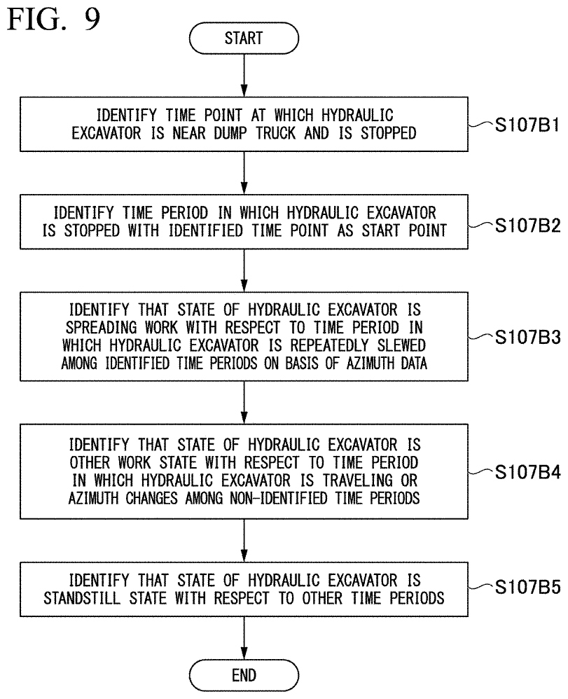

FIG. 9 is a flowchart illustrating a method of identifying a work state of the hydraulic excavator disposed in the banking place G2 in the first embodiment.

The state identifying unit 104 identifies a time point at which the dump truck M3 is located within a predetermined distance from the hydraulic excavator M1 disposed in the banking place G2, and the hydraulic excavator M1 and the dump truck M3 are stopped, on the basis of the time series of position data and the time series of traveling speeds (step S107B1). Next, the state identifying unit 104 identifies a time point at which at least the hydraulic excavator M1 is stopped with the identified time point as a start point (step S107B2). The reason why position data of the dump truck M3 after the start point is not used is that, in a case where the dump truck M3 finishes discharging earth and sand in the dump body thereof, the dump truck M3 is moved to the earth cut place G1 regardless of a work state of the hydraulic excavator M1. Next, the state identifying unit 104 identifies that a work state (the type of work) of the hydraulic excavator M1 is scattering work with respect to a time period in which the hydraulic excavator M1 is repeatedly slewed among the identified time periods on the basis of the time series of azimuth data (step S107B3).

Thereafter, the state identifying unit 104 executes the processes in step S107B4 and step S107B5, and identifies one of a work state of the hydraulic excavator M1 being other work states and a standstill state with respect to a time period in which a work state of the hydraulic excavator M1 is not identified. The processes in step S107B4 and step S107B5 are the same as the processes in step S107A3 and step S107A4.

«Method of Identifying Work State of Slope Excavator»

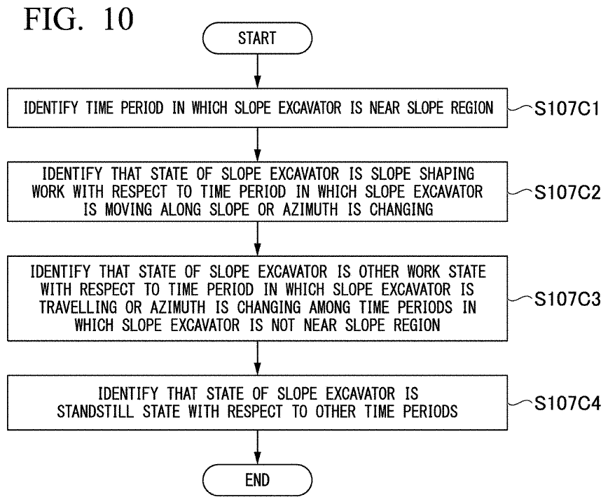

FIG. 10 is a flowchart illustrating a method of identifying a work state of a slope excavator in the first embodiment. The slope excavator indicates the hydraulic excavator M1 performing work of shaping a slope.

With respect to a slope excavator, the state identifying unit 104 identifies time periods in which the slope excavator is located within a predetermined distance from a slope region of design landform data on the basis of a time series of position data and the design landform data acquired by the design landform acquisition unit 105 (step S107C1). The state identifying unit 104 identifies that a work state (the type of work) of the slope excavator is slope shaping work with respect to a time period in which the slope excavator is being moved along a slope extending direction or an azimuth of the slope excavator is slewing among the identified time periods (step S107C2). The slope shaping work is work for the slope excavator to excavate and shape the slope region in the construction site in accordance with the design landform data.

Next, the state identifying unit 104 identifies that a work state of the slope excavator is other work states with respect to a time period in which the slope excavator is traveling or an azimuth of the slope excavator is changing among time periods in which a work state of the slope excavator is not identified, that is, the slope excavator is not located within a predetermined distance from the slope region (step S107C3). Next, the state identifying unit 104 identifies that a work state of the slope excavator is a standstill state with respect to the time periods in which a work state of the slope excavator is not identified (step S107C4).

«Method of Identifying Work State of Bulldozer M2»

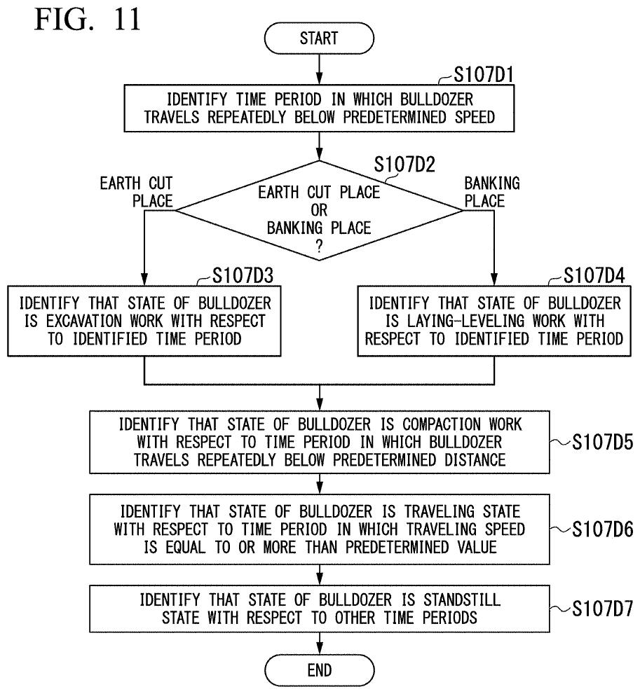

FIG. 11 is a flowchart illustrating a method of identifying a work state of the bulldozer in the first embodiment.

With respect to the bulldozer M2, the state identifying unit 104 identifies time periods in which the bulldozer M2 is repeatedly moved forward and backward, and a speed during forward movement is equal to or lower than a predetermined speed (for example, 5 kilometers per hour), on the basis of a time series of position data and a time series of traveling speeds (step S107D1). Next, the state identifying unit 104 determines whether the bulldozer M2 is disposed in the earth cut place G1 or the banking place G2 on the basis of the time series of position data (step S107D2). In a case where the bulldozer M2 is disposed in the earth cut place G1 (step S107D2: earth cut place), the state identifying unit 104 identifies that a work state (the type of work) of the bulldozer M2 is excavation-transport work with respect to the identified time periods (step S107D3). On the other hand, in a case where the bulldozer M2 is disposed in the banking place G2 (step S107D2: banking place), the state identifying unit 104 that a work state (the type of work) of the bulldozer M2 is laying-leveling work with respect to the identified time periods (step S107D4).

Next, the state identifying unit 104 identifies that a work state (the type of work) of the bulldozer M2 is compaction work with respect to a time period in which the bulldozer M2 is repeatedly moved forward and backward in a predetermined distance (for example, 8 meters) or less among time periods in which a work state of the bulldozer M2 is not identified (step S107D5).

Next, the state identifying unit 104 identifies that a work state of the bulldozer M2 is a traveling state with respect to a time period in which a traveling speed of the bulldozer M2 is equal to or more than a predetermined value among the time periods in which a work state of the bulldozer M2 is not identified (step S107D6).

Next, the state identifying unit 104 identifies that a work state of the bulldozer M2 is a standstill state with respect to the time periods in which a work state of the bulldozer M2 is not identified (step S107D7).

The state identifying unit 104 according to the first embodiment determines whether the type of work is excavation-transport work or laying-leveling work on the basis of a traveling speed of the bulldozer M2, but is not limited thereto. For example, in other embodiments, the state identifying unit 104 may determine whether the type of work is excavation-transport work or laying-leveling work on the basis of one or both of repeated traveling distances and a traveling speed of the bulldozer M2.

The state identifying unit 104 according to the first embodiment determines whether or not the type of work is compaction work on the basis of repeated traveling distances of the bulldozer M2, but is not limited thereto. For example, in other embodiments, the state identifying unit 104 may determine whether or not the type of work is compaction work on the basis of one or both of repeated traveling distances and a traveling speed of the bulldozer M2.

Generally, a traveling speed in excavation-transport work and laying-leveling work is lower than a traveling speed in compaction work. Generally, a traveling distance in excavation-transport work and laying-leveling work is longer than a traveling distance in compaction work.

«Method of Identifying Work State of Dump Truck M3»

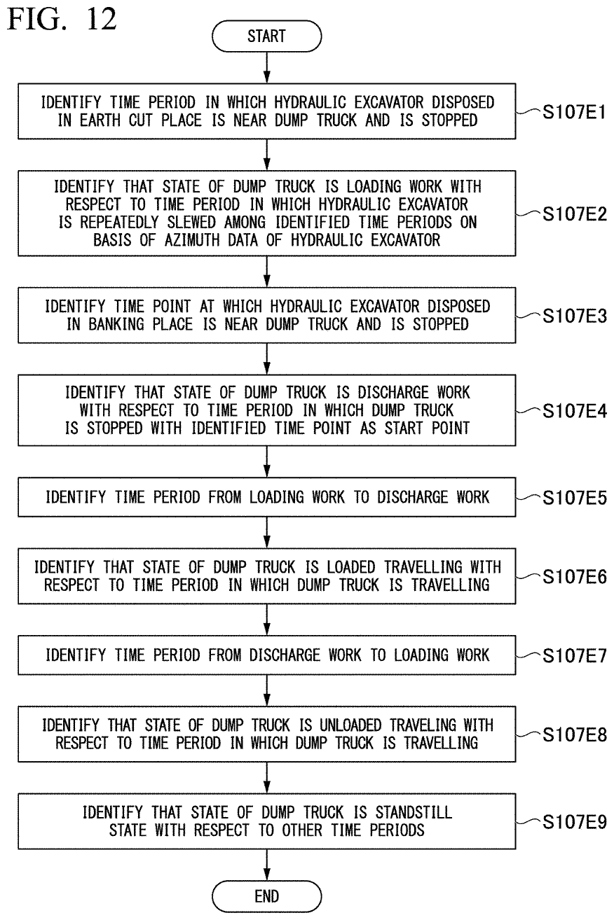

FIG. 12 is a flowchart illustrating a method of identifying a work state of the dump truck in the first embodiment.

The state identifying unit 104 identifies time periods in which the dump truck M3 is located within a predetermined distance from the hydraulic excavator M1 disposed in the earth cut place G1, and the hydraulic excavator M1 and the dump truck M3 are stopped, on the basis of a time series of position data and a time series of traveling speeds (step S107E1). Next, the state identifying unit 104 identifies that a work state (the type of work) of the dump truck M3 located within a predetermined distance from the hydraulic excavator M1 is a loading work state with respect to a time period in which the hydraulic excavator M1 is repeatedly slewed among the identified time periods on the basis of a time series of azimuth data (step S107E2).

The state identifying unit 104 identifies a time point at which the dump truck M3 is located within a predetermined distance from the hydraulic excavator M1 disposed in the banking place G2, and the hydraulic excavator M1 and the dump truck M3 are stopped, on the basis of a time series of position data and a time series of traveling speeds (step S107E3). Next, the state identifying unit 104 identifies that a work state (the type of work) of the dump truck M3 is a discharge work state with respect to a time period in which at least the dump truck M3 is stopped with the identified time point as a start point (step S107E4).

The state identifying unit 104 identifies a time period from an end time point of the loading work to a start time point of the discharge work among time periods in which, with respect to the dump truck M3, the loading work is not identified in step S107E2 and the discharge work is not identified in step S107E4 (step S107E5).

The state identifying unit 104 identifies that a work state (the type of work) of the dump truck M3 is loaded traveling with respect to a time period in which the dump truck M3 is traveling among the identified time periods on the basis of a time series of traveling speeds (step S107E6). The state identifying unit 104 identifies a time period from an end time point of the discharge work to a start time point of the loading work among the time periods in which, with respect to the dump truck M3, loading work is not identified in step S107E2 and discharge work is not identified in step S107E4 (step S107E7).

The state identifying unit 104 identifies that a work state (the type of work) of the dump truck M3 is unloaded traveling with respect to a time period in which the dump truck M3 is traveling among the identified time periods on the basis of a time series of traveling speeds (step S107E8). In other embodiments, the state identifying unit 104 may further determine whether a work state of the dump truck M3 immediately before a loading work state or a discharge work state is any one of turning traveling, backward traveling, and inside-location traveling, on the basis of a traveling speed, a traveling direction, and the like of the dump truck M3. For example, in a case where a traveling speed is low, the state identifying unit 104 may identify that a work state of the dump truck M3 is inside-location traveling. For example, in a case where a traveling direction is a backward direction, the state identifying unit 104 may identify that a work state of the dump truck M3 is backward traveling.

Next, the state identifying unit 104 identifies that the work state of the dump truck M3 is a standstill state with respect to a time period in which a work state of the dump truck M3 is not identified (step S107E9).

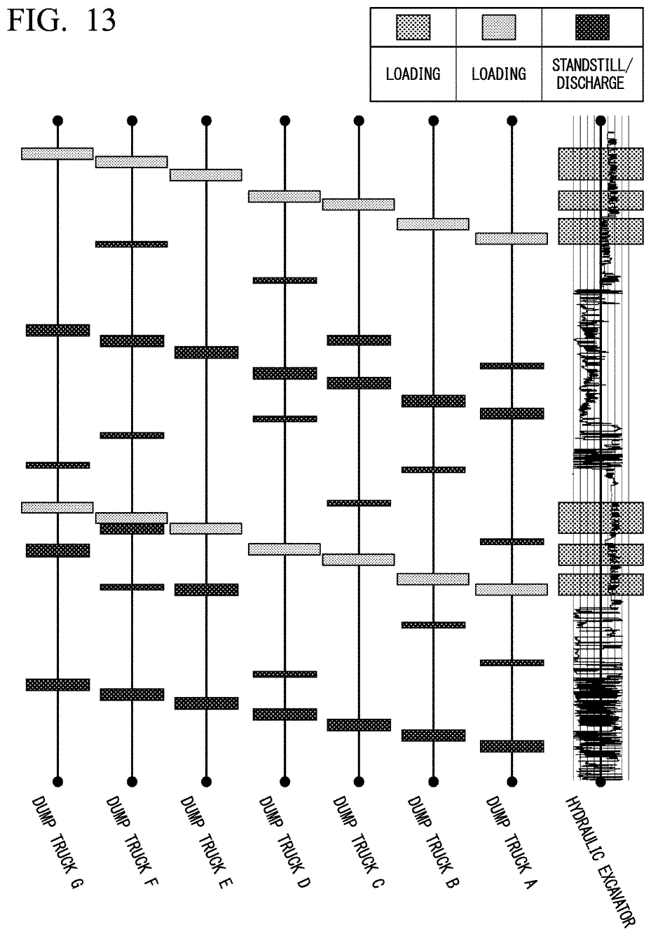

FIG. 13 illustrates an example of a time chart screen generated by the construction site management device according to the first embodiment.

In a case where the state identifying unit 104 identifies the state of each vehicle M in each time through the process in step S107, the time chart generation unit 106 generates, in step S108, a time chart in which a longitudinal axis is a time axis, and the vehicles M in a group, that is, a so-called fleet including the dump trucks M3 and the hydraulic excavators M1 are arranged on a transverse axis, as illustrated in FIG. 13. The vehicles M arranged on the longitudinal axis of the time chart include different individuals of the same type, and the individuals are identified by, for example, displaying identification numbers of the vehicles M. The time chart illustrated in FIG. 13 is, for example, a screen in which time charts respectively representing states of a single hydraulic excavator M1 disposed in the earth cut place G1 and eight dump trucks M3 which are loaded with earth and sand by the hydraulic excavator M1 and transport the earth and sand between the earth cut place G1 and the banking place G2 on the time basis are displayed on an identical screen with the time axis as a common axis. In other words, in the construction site G, the single hydraulic excavator M1 and the eight dump trucks M3 form a fleet. The time chart generation unit 106 superimposes a graph representing a time series of azimuth data of the hydraulic excavator M1 on the time chart representing a state of the hydraulic excavator M1.

Next, a detailed description will be made of a method in which the dynamic state image generation unit 107 generates a dynamic state image in step S109.

The dynamic state image is a moving image formed of a plurality of frame images. Each frame image is also an example of the dynamic state image. The dynamic state image generation unit 107 generates frame images from a start time of a target period to an end time thereof, and generates a dynamic state image by using a plurality of generated frame images.

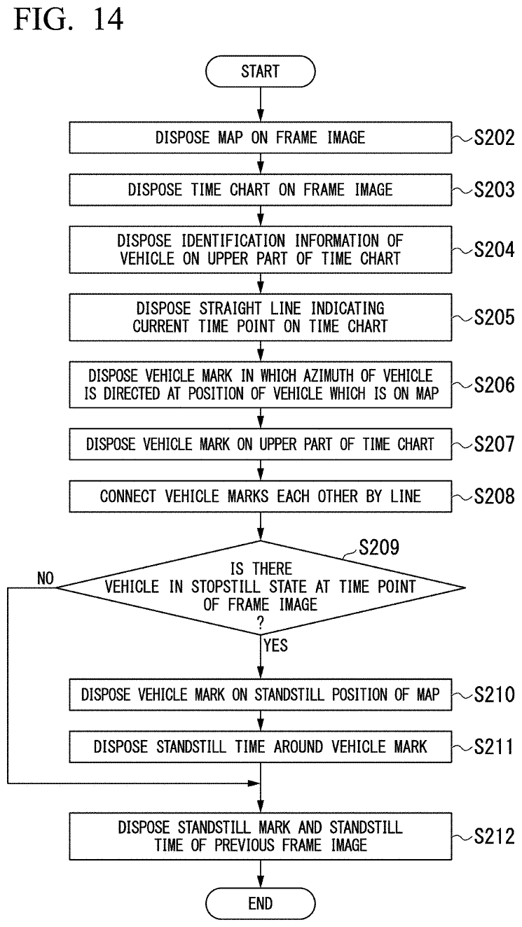

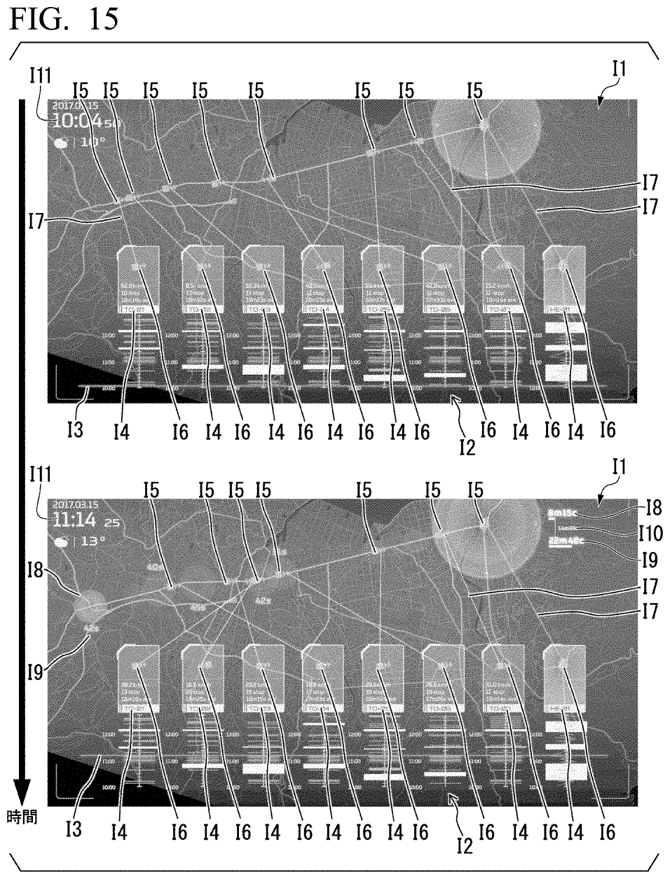

FIG. 14 is a flowchart illustrating a method of generating a frame image of a dynamic state image according to the first embodiment. FIG. 15 illustrates an example of a dynamic state image according to the first embodiment. Hereinafter, a description will be made of generating a frame image corresponding to each time point.

The dynamic state image generation unit 107 reads a map I1 including the construction site G, and disposes the map in a frame image (step S202). The map I1 is acquired by the map acquisition unit 109 from the storage 300 or an external server, and is stored in the main memory 200. In the same manner as in position data, the map acquisition unit acquires the map and then stores map data into the main memory. Thereafter, the dynamic state image generation unit extracts the map data, and generates a frame image. The dynamic state image generation unit 107 disposes a time chart I2 generated in step S108 at a predetermined portion of a lower part of the map in the frame image (step S203). Therefore, a display portion of the time chart I2 is fixed in overall dynamic state images. With respect to each vehicle M, the dynamic state image generation unit 107 disposes, for example, identification information I4, a traveling speed, the number of times of stop, and average stop time of the vehicle M on an upper part of the disposed time chart I2 (step S204). The dynamic state image generation unit 107 disposes a straight line I3 crossing the time chart I2 at a position corresponding to the current time on the time chart I2, and disposes the current time 111 at a predetermined position (step S205).

The dynamic state image generation unit 107 disposes a vehicle mark I5 inclined in an azimuth in which each vehicle M is directed, at a portion corresponding to location where each vehicle M is located at a time point represented by the frame image, on the map I1 in the frame image on the basis of a time series of position data and azimuth data of the vehicle M (step S206). In other words, a display portion and an azimuth of the vehicle mark I5 are different from each other between frame images. Therefore, a display portion of the vehicle mark I5 is temporally changed in overall dynamic state images. With respect to each vehicle M, the dynamic state image generation unit 107 disposes a vehicle mark I6 with the same inclination as that of the vehicle mark I5 disposed on the map, on an upper part of the time chart I2 related to the vehicle M (step S207). The dynamic state image generation unit 107 connects the vehicle mark I5 disposed on the upper part of the time chart I2 to the vehicle mark I6 disposed on the map I1 via a line I7 (step S208).

The dynamic state image generation unit 107 determines whether or not there is the vehicle M which is in a standstill state at the time point represented by the frame image on the basis of the state identified by the state identifying unit 104 (step S209). In a case where there is the vehicle M which is in a standstill state (step S209: YES), a standstill mark I8 is disposed at a position corresponding to a location where the vehicle M is located on the map (step S210). Regarding the depth of a color of the standstill mark I8, it is assumed that the color becomes deeper as a standstill period of time becomes longer. The dynamic state image generation unit 107 disposes a standstill period of time I9 around the standstill mark I8 (step S211).

In a case where the dynamic state image generation unit 107 disposes the standstill mark I8, or there is no vehicle M which is in a standstill state (step S209: YES), when the standstill mark I8 and the standstill period of time I9 are disposed in a frame image representing a time point earlier than the time point represented by the frame image, the dynamic state image generation unit 107 also disposes the identical standstill mark I8 and standstill period of time I9 in the frame image (step S212). The dynamic state image generation unit 107 may increase a transmittance of the standstill mark I8 disposed in the past frame image by a predetermined value more than that of the standstill mark I8 in the previous frame image. Consequently, in dynamic state images, the standstill mark I8 is not gradually displayed. Consequently, the dynamic state image generation unit 107 can generate a frame image at each time point.

Through the processes, the dynamic state image generation unit 107 can generate dynamic state images as illustrated in FIG. 15. Consequently, the output device 600 outputs the dynamic state images as illustrated in FIG. 15. The dynamic state image generation unit 107 may identify a loading state on the basis of a state identified by the state identifying unit 104, and may display a period of time from the loading start to the loading end, that is, the period of time I8 required for loading on a dynamic state image. The dynamic state image generation unit 107 may display a period of time I9 from the loading start to the next loading start (a time point at which the vehicle comes again to a loading region of the earth cut place G1 after discharging loaded earth and sand into the banking place G2) on a dynamic state image. The dynamic state image generation unit 107 may display a difference therebetween, that is, a period of time 110 required for the vehicle to leave the earth cut place and then come to the earth cut place again via the banking place, on a dynamic state image.

The dynamic state image generation unit 107 may display, as other measurement periods of time, a period of time for which the operator of the hydraulic excavator M1 can perform other work on the basis of a period of time required for loading onto all dump trucks M3 in a fleet including the dump trucks M3 and the hydraulic excavator M1 (a period of time from the start time of loading onto the leading dump truck M3 to the end time of loading onto the last dump truck M3), or a period of time required for a certain dump truck M3 to complete one cycle (for example, a period of time from the start time of first loading to the start time of second loading), on a dynamic state image.

### ADVANTAGEOUS EFFECTS

As mentioned above, according to the first embodiment, the construction site management device 10 outputs a dynamic state image including the map I1, the vehicle mark I5 representing a portion corresponding to a location where the vehicle M is located, the identification information I4 of the vehicle M, and the standstill mark I8 representing a portion corresponding to a standstill location. Consequently, a manager of the construction site G can easily recognize a bottleneck in the work of the vehicle M. The manager of the construction site G visually recognizes output dynamic state images, and can thus recognize the trajectory of traveling of the vehicle M and a location where a standstill occurs on the trajectory.

A dynamic state image according to the first embodiment includes a standstill period of time of the vehicle M at a location indicated by the standstill mark I8. Consequently, the manager of the construction site G visually recognizes output dynamic state images, and can thus recognize a trajectory of traveling of the vehicle M, and a location where on the trajectory and a period of time for which a standstill occurs. This may be recognized by making display aspects of the standstill mark I8 different from each other depending on a length of a standstill period of time. The standstill mark I8 according to the first embodiment has different color depths depending on a length of a standstill period of time, but is not limited thereto. For example, in other embodiments, other aspects representing a standstill period of time, such as a hue, a size, or a blinking speed of the standstill mark I8 may be changed depending on a length of a standstill period of time. In an aspect representing a standstill period of time according to other embodiments, a standstill period of time may be displayed in the standstill mark I8.

A dynamic state image according to the first embodiment includes a time chart displaying a state of the vehicle M at each time point. Consequently, the manager of the construction site G visually recognizes output dynamic state images, and can thus recognize the efficiency of work of the vehicle M.

A dynamic state image according to the first embodiment includes the line I7 connecting the time chart I2 disposed at a predetermined portion to the vehicle mark I5 of which a position is temporally changed. Consequently, the manager of the construction site G visually recognizes output dynamic state images, and can thus easily recognize which time chart I2 represents a state of the vehicle mark I5 moved on the map. The construction site management device 10 according to other embodiments may use methods other than the line I7 as information associating the vehicle mark I5 on the map with the time chart I2 on a dynamic state image. For example, the construction site management device 10 according to other embodiments may change a color and a shape of the vehicle mark I5 for each vehicle M, and may display identification information of the vehicle M around the vehicle mark I5.

The construction site management device 10 according to the first embodiment identifies a work state of the vehicle M on the basis of a positional relationship between the vehicle M and another vehicle M by using a GNSS, but is not limited thereto. For example, the construction site management device 10 according to other embodiments may identify a work state of the vehicle M by using a positional relationship between the vehicles M through inter-vehicle communication.

In the first embodiment, a time chart screen is generated in which time charts of the respective vehicles M having a common time axis are arranged, the time charts having a transverse axis as the time axis and a longitudinal axis on which the vehicles M forming a fleet are arranged, but this is only an example. For example, in other embodiments, in a form in which an appropriate time axis is provided for each vehicle M, a time chart screen may be generated in other forms such as a longitudinal axis being set as the time axis.

### Second Embodiment

Next, a second embodiment will be described. The construction site management device 10 according to the first embodiment determines that a work state of the dump truck M3 is loaded traveling in a case of traveling after loading work and before discharge work, and that a work state thereof is unloaded traveling in a case of traveling after discharge work and before loading work. In contrast, in the second embodiment, the state of the dump truck M3 is identified on the basis of position information of the dump truck M3.

A state of the dump truck M3 identified by the construction site management device 10 according to the second embodiment includes outside loaded traveling in which the dump truck M3 is traveling on a general road in a loaded state, outside unloaded traveling in which the dump truck M3 is traveling on a general road in an unloaded state, turning traveling in which the dump truck M3 is traveling in a turning region provided in the earth cut place G1 or the banking place G2, backward traveling in which the dump truck M3 is traveling in a backward region provided in the earth cut place G1 or the banking place G2, and inside-location traveling in which the dump truck M3 is normally traveling in the earth cut place G1 or the banking place G2. The earth cut place G1, the banking place G2, the turning region, and the backward region are designated as, for example, geofences in advance. In this case, the state identifying unit 104 identifies a state of the dump truck M3 on the basis of whether or not a position indicated by position data of the dump truck M3 is inside a geofence.

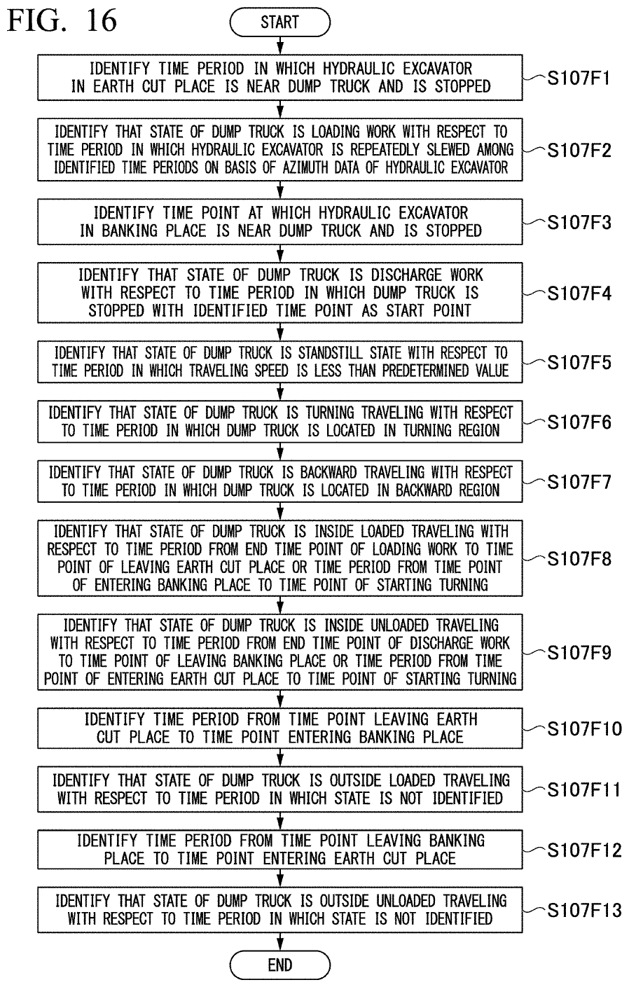

FIG. 16 is a flowchart illustrating a method of identifying a state of the dump truck in the second embodiment.

The state identifying unit 104 identifies time periods in which the dump truck M3 is located within a predetermined distance from the hydraulic excavator M1 disposed in the earth cut place G1, and the hydraulic excavator M1 and the dump truck M3 are stopped, on the basis of a time series of position data and a time series of traveling speeds (step S107F1). Next, the state identifying unit 104 identifies that a work state (the type of work) of the dump truck M3 located within a predetermined distance from the hydraulic excavator M1 is a loading work state with respect to a time period in which the hydraulic excavator M1 is repeatedly slewed among the identified time periods on the basis of a time series of azimuth data (step S107F2).

The state identifying unit 104 identifies a time point at which the dump truck M3 is located within a predetermined distance from the hydraulic excavator M1 disposed in the banking place G2, and the hydraulic excavator M1 and the dump truck M3 are stopped, on the basis of a time series of position data and a time series of traveling speeds (step S107F3). Next, the state identifying unit 104 identifies that a work state (the type of work) of the dump truck M3 is a discharge work state with respect to a time period in which at least the dump truck M3 is stopped with the identified time point as a start point (step S107F4).

The state identifying unit 104 identifies that a work state of the dump truck M3 is a standstill state with respect to a time period in which a traveling speed of the dump truck M3 is less than a predetermined value among time periods in which a work state of the dump truck M3 is not identified (step S107F5).

The state identifying unit 104 identifies that a work state of the dump truck M3 is turning traveling with respect to a time period in which the dump truck M3 is located in the turning region among the time periods in which a work state of the dump truck M3 is not identified (step S107F6). The state identifying unit 104 identifies that a work state of the dump truck M3 is backward traveling with respect to a time period in which the dump truck M3 is located in the backward region among the time periods in which a work state of the dump truck M3 is not identified (step S107F7).

The state identifying unit 104 identifies that a work state of the dump truck M3 is inside loaded traveling with respect to a time period from an end time point of loading work in the earth cut place G1 to a time point at which the dump truck M3 leaves the earth cut place G1 or a time period from a time point at which the dump truck M3 enters the banking place G2 to a time point at which the dump truck M3 enters the turning region of the banking place G2 among the time periods in which a work state of the dump truck M3 is not identified (step S107F8). The state identifying unit 104 identifies that a work state of the dump truck M3 is inside unloaded traveling with respect to a time period from an end time point of discharge work in the banking place G2 to a time point at which the dump truck M3 leaves the banking place G2 or a time period from a time point at which the dump truck M3 enters the earth cut place G1 to a time point at which the dump truck M3 enters the turning region of the earth cut place G1 among the time periods in which a work state of the dump truck M3 is not identified (step S107F9). In other words, even though the dump truck M3 is located in the earth cut place G1 or the banking place G2, in a case where the dump truck M3 is located in the turning region or the backward region of the earth cut place G1 or the banking place G2, a work state of the dump truck M3 is not inside loaded traveling or inside unloaded traveling.

The state identifying unit 104 identifies time periods from a time point at which the dump truck M3 leaves the earth cut place G1 to a time point at which the dump truck M3 enters the banking place G2 (step S107F10). The state identifying unit 104 identifies that a work state of the dump truck M3 is outside loaded traveling with respect to a time period in which a work state of the dump truck M3 is not identified among the time periods identified in step S107F10 (step S107F11).

The state identifying unit 104 identifies time periods from a time point at which the dump truck M3 leaves the banking place G2 to a time point at which the dump truck M3 enters the earth cut place G1 (step S107F12). The state identifying unit 104 identifies that a work state of the dump truck M3 is outside unloaded traveling with respect to a time period in which a work state of the dump truck M3 is not identified among the time periods identified in step S107F12 (step S107F13).

In other words, the simulation system 10 according to the second embodiment identifies a work state of the vehicle M on the basis of a position of the vehicle M, that is, whether or not the vehicle M is present in a predetermined region, whether or not the vehicle M enters a region, or whether or not the vehicle M leaves a region.

### Other Embodiments

As mentioned above, embodiments has been described with reference to the drawings, but a specific configuration is not limited to the above-described configurations, and various design changes may occur.

For example, a dynamic state image according to the embodiments is a moving image. On the other hand, other embodiments are not limited thereto. For example, a dynamic state image according to other embodiments may be an image representing a dynamic state of the vehicle M in a predetermined period using still images by setting a curve representing a trajectory of a position of the vehicle M as the vehicle mark I5.

The dynamic state images illustrated in FIG. 15 represent states of the hydraulic excavator M1 and the dump truck M3. On the other hand, a time chart generated by the construction site management device 10 according to other embodiments is not limited to indicating a relationship between the hydraulic excavator M1 and the dump truck M3, and may include states of other vehicles M (for example, the dump trucks M3).

In the embodiments mentioned above, the construction site management device 10 identifies a position of each vehicle M in each period of time or every predetermined period of time as a time-based position, and generates a dynamic state image on the basis thereof, but is not limited to. For example, in other embodiments, the construction site management device 10 may identify a position of each vehicle M in an irregular period of time as a time-based position, so as to generate a dynamic state image on the basis thereof.

In the embodiments mentioned above, the hydraulic excavator M1, the bulldozer M2, and the dump truck M3 have been described as examples of the vehicle M, but are not limited thereto. For example, the construction site management device 10 may identify a state of a wheel loader or a road roller, and may generate a time chart. States of the wheel loader and the road roller may be obtained according to the same method as the method of obtaining a state of the bulldozer M2.

The hydraulic excavator M1 according to other embodiments may shape a groove. A work state and a parameter of the hydraulic excavator M1 shaping a groove may be obtained according to the same method as the method of obtaining a work state and a parameter of the slope excavator. Examples of parameters related to an amount of work in groove excavation work may include a distance of a groove, an area of the groove, or an earth amount of the groove, excavated and shaped per unit time. The groove excavation work is an example of shaping work.

The hydraulic excavator M1 according to other embodiments may perform excavation work without loading. For example, the hydraulic excavator M1 may excavate excavation target earth and sand, and may discharge the excavated earth and sand around another loading excavator such that the loading excavator easily excavates the earth and sand. In this case, excavation work is determined by identifying a time period in which the hydraulic excavator M1 is stopped and is repeatedly slewed. In determination of the excavation work, a condition in which the hydraulic excavator M1 is near the dump truck M3 may not be referred to. A parameter for the excavation work in this case may be obtained according to the same method as the method of obtaining a parameter for loading work of the hydraulic excavator M1.

In the construction site management device 10 according to the embodiments mentioned above, a description has been made of a case where the program is stored in the storage 300, but this is only an example. For example, in other embodiments, the program may be delivered to the construction site management device 10 via a communication line. In this case, the construction site management device 10 develops the delivered program to the main memory 200, and executes the processes.

The program may realize some of the functions mentioned above. For example, the program may realize the functions through a combination with another program already stored in the storage 300 or a combination with another program installed in another device.

The construction site management device 10 may include a programmable logic device (PLD) in addition to the configuration or instead of the configuration. Examples of the PLD may include a programmable array logic (PAL), a generic array logic (GAL), a complex programmable logic device (CPLD), and a field programmable gate array (FPGA). In this case, some of the functions realized by the processor 100 may be realized by the PLD.

### INDUSTRIAL APPLICABILITY

The construction site management device enables a bottleneck in the work of a transport vehicle and a work machine to be easily recognized.

### REFERENCE SIGNS LIST

10 CONSTRUCTION SITE MANAGEMENT DEVICE
100 PROCESSOR
200 MAIN MEMORY
300 STORAGE
400 INTERFACE
500 INPUT DEVICE
600 OUTPUT DEVICE
101 POSITION RECEPTION UNIT
102 AZIMUTH RECEPTION UNIT
103 TIME-SERIES RECORDING UNIT
104 STATE IDENTIFYING UNIT
105 DESIGN LANDFORM ACQUISITION UNIT
106 TIME CHART GENERATION UNIT
107 DYNAMIC STATE IMAGE GENERATION UNIT
108 output control unit
201 TIME-SERIES STORAGE UNIT
G CONSTRUCTION SITE
G1 EARTH CUT PLACE
G2 BANKING PLACE
M WORK MACHINE
M1 HYDRAULIC EXCAVATOR
M2 BULLDOZER
M3 DUMP TRUCK

1. A construction site management device comprising:
a map acquisition unit that acquires map information including a construction site and a traveling path;
a position data acquisition unit that acquires a time series of position data of a vehicle;
a dynamic state image generation unit that generates a dynamic state image which includes the map information and a vehicle mark representing a portion corresponding to a location where the vehicle disposed in the construction site on the map information is located and which represents a dynamic state of the vehicle in a predetermined period, on the basis of the time series of position data; and
an output control unit that outputs an output signal enabling the dynamic state image to be output, to an output device.

2. The construction site management device according to claim 1,
wherein the dynamic state image includes a standstill mark representing a portion corresponding to a location where the vehicle is at a standstill, and is displayed in an aspect of representing a standstill period of time of the vehicle at a location indicated by the standstill mark.

3. The construction site management device according to claim 1, wherein the dynamic state image includes a time chart which displays a work state of the vehicle at each time point.

4. The construction site management device according to claim 3,
wherein a display portion of the time chart is fixed in the dynamic state image,
wherein a display portion of the vehicle mark is temporally changed in the dynamic state image, and
wherein the dynamic state image includes information for associating the time chart with the vehicle mark.

5. The construction site management device according to claim 3, further comprising:
a work state identifying unit that identifies a work state of the vehicle at each time point on the basis of the time series of position data of the vehicle,
wherein the dynamic state image generation unit generates the dynamic state image on the basis of the time series of position data and the work state identified by the work state identifying unit.

6. A construction site management method comprising:
acquiring map information including a construction site and a traveling path;
acquiring a time series of position data of a vehicle;
generating a dynamic state image which includes the map information and a vehicle mark representing a portion corresponding to a location where the vehicle disposed in the construction site on the map information is located and which represents a dynamic state of the vehicle in a predetermined period, on the basis of the time series of position data; and
outputting an output signal enabling the dynamic state image to be output, to an output device.

7. The construction site management device according to claim 2,
wherein the dynamic state image includes a time chart which displays a work state of the vehicle at each time point.

8. The construction site management device according to claim 4, further comprising:
a work state identifying unit that identifies a work state of the vehicle at each time point on the basis of the time series of position data of the vehicle,
wherein the dynamic state image generation unit generates the dynamic state image on the basis of the time series of position data and the work state identified by the work state identifying unit.

9. The construction site management device according to claim 7, further comprising:
a work state identifying unit that identifies a work state of the vehicle at each time point on the basis of the time series of position data of the vehicle,
wherein the dynamic state image generation unit generates the dynamic state image on the basis of the time series of position data and the work state identified by the work state identifying unit.
